(19) United States
(12) Patent Application Publication
(10) Pub. No.: US 2023/0177552 A1
(43) Pub. Date: Jun. 8, 2023

(54) CODE GENERATION PLATFORM AND METHOD THEREOF

(71) Applicant: David S. Lapine Co. Inc, Stamford, CT (US)

(72) Inventors: Chetan Shah, Stamford, CT (US); Noah Lapine, Stamford, CT (US); Paul Lapine, Stamford, CT (US); Seth Diamond, Stamford, CT (US)

(21) Appl. No.: 18/105,689

(22) Filed: Feb. 3, 2023

Related U.S. Application Data
(63) Continuation-in-part of application No. 17/368,326, filed on Jul. 6, 2021, now abandoned.
(60) Provisional application No. 63/048,471, filed on Jul. 6, 2020.

(51) Int. Cl. G06Q 30/0207; G06Q 30/0235

(52) U.S. Cl. CPC G06Q 30/0222; G06Q 30/0235; G06Q 30/0239

(57) ABSTRACT

The present subject matter provides concept related to a code generation platform and method thereof. In this respect, the code generation platform and method include a code generation engine which allows personalized set of electronic redemption codes to be generated based on specific attributes, such as geography, random distribution rules, denominations, role, or function. In this respect, the code generation platform includes a code definition module and an entity definition module. Both work in association with the code generation engine to generate electronic redemption codes based on the rules configured in the code generation engine.

### CROSS-REFERENCE TO RELATED APPLICATION

This application claims the benefit of and is a continuation-in-part of U.S Non provisional Application 17/368326: A CODE GENERATION PLATFORM AND METHOD THEREOF that claims the priority of U.S. Provisional Application No. 63/048,471 filed Jul. 06, 2020, all of which are incorporated herein by reference in its entirety.

### TECHNICAL FIELD

The present disclosure relates to computer-implemented methods and systems for generating electronic codes and, in particular, to methods and systems for generating electronic codes generating personalized electronic codes.

### BACKGROUND

Over the years online e platform became huge success worldwide. Every other vendor is trying to innovate and provide more features on their online e platforms to provide better, efficient and customize shopping experiences to the users. For any vendor or service provider who are running an online store, they are familiar with the fact that customers have varying needs when it comes to customization of servicers offered on such platform. To provide the best customize shopping experience possible, it is important to anticipate the customer needs and have systems or technical solutions in place to support them.

For example, a random code generator may be understood as a platform or device for generating numbers in a random manner. Random code generators are used in a variety of technical fields. For instance, a random code generator may be implemented in a gaming industry to generate random codes. In another example, a random code generator may be used on an e platform for redeeming a prize product offered by an entity to its employees.

In one of the conventional solutions offered by the US20160335655A1 provides systems and methods of rule-based code generation. In this disclosure, coupon and consumer identifiers are encoded directly or indirectly into coupon barcodes, and upon redemption of coupons, the coupon and consumer identifiers are used to identify fraudulent duplicate redemptions of coupons by consumers. Scores are created based on consumer redemption histories and used to represent a consumer’s past history for over-redeeming electronic coupons. When a consumer is subsequently presented with an opportunity to receive another electronic coupon offer, the consumer’s score can be checked in real-time in advance, and the offer can be tailored, adjusted, or even not presented at all to account for the consumer’s past propensity to over-redeem coupons. A consumer’s score can be checked in real-time upon presentation of a coupon and the coupon can be accepted or rejected based on the score.

In another conventional solutions offered by the CN104573442A discloses an e-coupon generation method and device. In this disclosure, the e-coupon generation method includes acquiring description information used for representing content of e-coupons; acquiring verification information of the e-coupons, wherein the verification information is used for verifying effectiveness of the e-coupons and identity information of e-coupons holders; generating the e-coupons according to the description information and the verification information, wherein the description information is used as plaintext parts of the e-coupons and the verification information is used as ciphertext parts of the e-coupons.

In another conventional solutions offered by the CN110543471A discloses a method and a server for generating a coupon code. In this disclosure a method for generating a coupon code is provided which is applied to a server. The method includes get coupon code data and generate the real-time coupon code in a fixed format from the coupon code data. Further, before writing into the database of the server, traversing the database to see if there is a reference coupon code that duplicates the real-time coupon code. If yes, the real-time coupon code is discarded. If not, write the real-time coupon code into the database.

In another conventional solutions offered by the CN108510327A discloses a coupon generating method and system. The method comprises the steps of firstly obtaining a coupon serial number and user preferential information and encrypting the coupon serial number to obtain a coupon identity code; carrying out two-dimensional code coding on the user preferential information and the coupon identity code to generate a two-dimensional code; and generating coupon image text information according to the user preferential information and generating a coupon according to the two-dimensional code and the coupon image text information. According to the method, an identity two-dimensional code is given to each coupon and each identity two-dimensional code is unique and not repetitive, so that coupons can be distinguished from each other and are not easy to copy.

### SUMMARY

This summary is provided to introduce concepts related to a methods and systems for generating personalized electronic codes. This summary is neither intended to identify essential features of the present subject matter nor is it intended for use in determining or limiting the scope of the present subject matter. For example, various embodiments herein may include one or more systems and methods for generating personalized electronic codes.

In one of the embodiments, a computer implemented method for generating personalized electronic codes is disclosed. The method comprises registering, by an input module, one or more organizations in a database based on verification using a unique identification process. In one example, the one or more organizations are requesting personalized electronic redemption codes. Upon registering the method comprises creating, by an entity definition module, one or more entities for each of the one or more organization and generating, by a code definition module, one or more entity transactions associated with the one or more entities. Further to generating, the method comprises defining, by the code definition module, a code sequence configuration. In one example. the code sequence configuration comprises one or more of a maximum and a minimum number of characters, a list of inclusion and a list of exclusions. Further, the list of exclusion, and the list of inclusion comprises characters, words, and a sequence of characters and alphabets. Subsequently the method comprises generating, by the code definition module, at least one program to generate one or more set of personalized electronic redemption codes based on code sequence configuration and a set of processes. In one example, the program is a software code. Further to geniting, the method comprises associating, by the code definition module, at least one program with one of the one or more entities or the one or more entity transactions and generating, by a code generator module, the one or more personalized set of electronic redemption codes for each organization based on execution of the program.

In one of the embodiments, a personalized electronic codes generation platform is disclosed. The platform comprises at least one processor, and at least one memory. The platform further comprises an input module, an entity definition module, a code definition module, and a code generator module coupled with the processor and the memory,. In example, the platform is configured to register, by the input module, one or more organizations in a database based on verification using a unique identification process, wherein the one or more organizations are requesting personalized electronic redemption codes. Further to registering the platform is configured to create, by the entity definition module, one or more entities for each of the one or more organization and generate, by the code definition module, one or more entity transactions associated with the one or more entities. Subsequently the platform is configured to define, by the code definition module, a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets and generate, by the code definition module, at least one program to generate one or more set of personalized electronic redemption codes based on code sequence configuration and a set of processes, wherein the program is a software code. Finally, the platform is configured to associate, by the code definition module, at least one program with one of the one or more entities or the one or more entity transactions and generate, by a code generator module, the one or more personalized set of electronic redemption codes for each organization based on execution of the program.

In another embodiment, a non-transitory computer-readable medium storing processor-executable instructions that, when executed by one or more processors, are to cause the one or more processors to execute one or more instructions is disclosed. The non-transitory computer-readable medium comprise the instruction to register one or more organizations in a database based on verification using a unique identification process, wherein the one or more organizations are requesting personalized electronic redemption codes and create one or more entities for each of the one or more organization. Further the non-transitory computer-readable medium comprise the instruction to generate one or more entity transactions associated with the one or more entities and define a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets. Further the non-transitory computer-readable medium comprise the instruction to generate, at least one program to generate one or more set of personalized electronic redemption codes based on code sequence configuration and a set of processes, wherein the program is a software code and associate at least one program with one of the one or more entities or the one or more entity transactions. Finally, the non-transitory computer-readable medium comprise the instruction to generate the one or more personalized set of electronic redemption codes for each organization based on execution of the program.

### BRIEF DESCRIPTION OF ACCOMPANYING DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates a block diagram depicting a personalized electronic codes generation platform, according to an exemplary implementation of the present subject matter.

FIG. 2 illustrates a block diagram depicting a code generation platform, according to an exemplary implementation of the present subject matter.

FIG. 3 illustrates a block diagram depicting a master data for each of the parameters for generating electronic redemption codes, according to an exemplary implementation of the present subject matter.

FIG. 4 illustrates a block diagram depicting a configuration of program to generate set of electronic redemption codes, according to an exemplary implementation of the present subject matter.

FIG. 5 illustrate a flowchart depicting a complete process for generating personalized electronic codes, according to an exemplary implementation of the present subject matter.

FIG. 6 illustrate a flowchart depicting a computer implemented method for generating personalized electronic codes, according to an exemplary implementation of the present subject matter.

It should be appreciated by those skilled in the art that any block diagrams herein represent conceptual views of illustrative systems embodying the principles of the present subject matter. Similarly, it will be appreciated that any flowcharts, flow diagrams, and the like represent various processes which may be substantially represented in computer readable medium and so executed by a computer or processor, whether or not such computer or processor is explicitly shown.

### DETAILED DESCRIPTION

In the following description, for the purpose of explanation, specific details are set forth in order to provide an understanding of the present subject matter. It will be apparent, however, to one skilled in the art that the present subject matter may be practiced without these details. One skilled in the art will recognize that embodiments of the present subject matter, some of which are described below, may be incorporated into a number of systems. The various embodiments of the present subject matter provide a system and a method for generating personalized electronic codes.

Furthermore, connections between components and/or modules within the figures are not intended to be limited to direct connections. Rather, these components and modules may be modified, re-formatted or otherwise changed by intermediary components and modules.

References in the present subject matter to “one embodiment” or “an embodiment” mean that a particular feature, structure, characteristic, or function described in connection with the embodiment is included in at least one embodiment of the subject matter. The appearances of the phrase “in one embodiment” in various places in the specification are not necessarily all referring to the same embodiment.

Further, to the above description, conventional solutions, fail to disclose any personalized code generation. Neither they teach about the dual function of a merchandise redemption and personalization coupled with a variable code generation platform. The problem in the conventional system is increase multi fold where there are multiple organization requesting for multiple different type of personalized code simultaneous. This further increase when the organizations require quick turnaround. Further writing/generating a software code also referred to as a program for each personalized code generation considering legacy interdependencies is not disclosed by the convention art. Further reuse of the programs generated by organization over the period is also not disclosed by conventional art. Therefore, there is a need of a system and method to provide better and more efficient electronic code generator platform.

Additionally, the conventionally known techniques and the redemption code generation platforms, available in the art, generate redemption codes in the form of a random alpha-numeric series of fixed length. These random alpha-numeric series is then emailed or printed on gift cards and may be distributed to Employs of an Organization. Such redemption codes are also used in conducting electronic campaign for launch of new products in the market by some organizations. It must be noted that, multiple sets of redemption codes may be generated for various organization for various reasons. Each redemption codes may be associated with a different characteristic/ feature such as the percentage of discount, the maximum amount of discount, the validity date of the redemption code, and the like. However, these characteristics are always hidden from the acceptor of the redemption code and is only visible to him once he enters the redemption code for during the redemption process. Also, since the redemption code is a random alphanumeric string, it is very difficult for management of such redemption codes especially when these redemption codes are to be distributed to different teams with altogether different offers. If a redemption code is misplaced, it becomes even more difficult to manage such redemption codes. As a result, the acceptor of the redemption code is not able to fully utilize the redemption codes. Further, the generation of such code consumes a tremendous resource.

There are some solutions available where this information (applicable discount, validity, type of goods) is printed separate from the redemption code. However, if such information is printed separately, a highly sophisticated database system and a lot of mapping process is required in order to link each of randomly generated redemption code with the corresponding characteristics/ feature (percentage of discount, the maximum amount of discount, the validity date of the redemption code). This results into increase in utilization of resources such as processing power, database space and computational complexity and many more.

In the present subject matter instead of managing the associated characteristics/ features (percentage of discount, the maximum amount of discount, the validity date of the redemption code) with each redemption code separately, this information is embedded into the redemption code itself by the program also a separate program is generated for each redemption code generating process. Thus, the computational complexity of the overall redemption generation platforms is drastically reduced. For example, considering the existing art, in order to manage a redemption code and associated characteristics such as percentage of discount, the maximum amount of discount, and the validity date of the redemption code at least one database table with five different columns is required. One separate column for the serial Number, one separate column for the redemption code, one separate column for the percentage of discount, one separate column for the maximum amount of discount, and one separate column for the validity date of the redemption code may be employed. Adding to the complexity, for different entities, altogether different tables may be maintained further increasing the storage space requirement. On the contrary, in the Applicant claimed subject matter, a program is generated that generated the code such that all the customization and personalized information is stored in the redemption code itself. Thus, instead of maintaining database with separate tables for different entities, wherein each table maintains separate columns for storing characteristic information, in the present invention a single database table with the personalized information can be incorporated. This results into numerous advantages including less requirement of processing power, database space and computational complexity and many more.

In an implementation, the present subject matter discloses a computer implemented method for generating personalized electronic codes. The method includes registering, by an input module, details of one or more organizations requesting a set of electronic redemption codes in a database. The step of registering, by the input module, further includes verifying the details of the one or more organizations requesting the set of electronic redemption codes in the database using a unique identification process. A unique identification process may be one of an OTP, unique id and the like. Further, the step of verifying further includes editing the details of the one or more organizations requesting the set of electronic redemption codes in the database if the details of the one or more organizations is already available in the database. Here the one or more organizations refer to one or more business entity requesting the set of electronic redemption codes. For serving the purpose of the method for generating personalized electronic codes to generate codes for multiple stakeholders/business entities, a master data is available, wherein a user can create the one or more organizations who has requested the codes.

In the present implementation, the method further includes creating, by an entity definition module, one or more entities having a list of parameters required for electronic redemption codes generation. Here the one or more entities refer to as a thing with distinct and independent existence used for the electronic redemption codes. The entity can also be referred as a set of distinct values, or a defined list required for the electronic redemption codes generation. For example, if an organization wants to generate codes based on four regions (East, West, South, North), the entity named as “Region” is defined in the code generation method (which is set of four (4) region values). Further, the step of creating the one or more entities further includes verifying and editing the details of the one or more entities if the details of the one or more entities is already available in an entity master of the database. Furthermore, the step of editing the details of the one or more entities further includes defining entity transaction value length as well as changing the status of the entity.

In the present implementation, the method further includes creating, by a code definition module, one or more entity transactions. Here the one or more entity transactions refer to a list of value of an associated entity. Every entity with the entity types as “defined list” may have its own set of values. Here, for example, the entity transaction includes entity transaction name, associated entity and entity transaction code. In another example, if one can consider “state” as an entity, then the entity transaction values will be its associated list values, viz. Alabama, Alaska, Connecticut, California, and the like. Further, the step of creating one or more entity transactions further includes verifying and editing the existing entity transaction details as well as changing the status of the entity transaction.

In the present implementation, the method further includes generating, by the code definition module, a code sequence configuration. In one example, the code sequence configuration comprises one or more of a maximum and a minimum number of characters, a list of inclusion and a list of exclusions, wherein the list of exclusion, and the list of inclusion comprises characters, words, and a sequence of characters and alphabets. Another example, the code sequence configuration includes random numbers or characters, separator, text, entity code, code end date, status and the like. Furthermore, here the defining the code sequence configuration further includes defining number of characters in the code and providing a list of exclusions of certain characters or a sequence of character especially alphabets which does not become a part of the final generated set of electronic redemption codes. For example, a program to generate a set of electronic codes may include a nine (9) characters code must be generated where the character “o”, “1”, “!”, “#” should be excluded while generating the electronic codes, “S” “H” “I” and “T” should be excluded in the particular order. The electronic codes must have an end date which state that the electronic codes must expire within 90 days from the date these are generated. In the present implementation, of characters in the code sequence configuration further includes providing an option to the user to select one or more specific characters at one or more specific code sequences as per the user requirement. For example, a user wants to generate a 6 characters long code in which character number 4 from the right must be an entity and character number 5 from the right must be a city.

In one embodiment, the method further comprising allowing a user to define the one or more entity as a part of the final generated set of electronic redemption codes, and wherein the final generated set of electronic redemption codes validity based on type of the code end date selected at the time of generating codes. For example, a user can define that his nine (9) character long codes must start with the entity code having “DL” and followed by five (5) characters randomly generated followed by two (2) characters city code “NY” with a validity of 31 days from the date of generation of such codes. In another example, the code sequence can be defined as “random numbers”- “city code” - “random numbers” with a validity of 37 days from the date of generation of such codes.

In the present implementation, the method further includes generating, by the code definition module, at least one program based on the code sequence configuration and set of processes. Here the program refers a software code, i.e. a executable file. For example, the program is a .exe generated for execution, which include software code associate with the code sequence configuration and other meta data such. In the generating process of the program includes selecting entities for electronic redemption codes generation. Further, generation of the program includes creating a test .exe based for testing of the generated personalized code and preview. Further the generating comprises editing the tests.exe code file for generating the final program.

In the present implementation, the method further includes associating, by the code definition module, at least one program with one of the one or more entities or the one or more entity transactions to generate the one or more set of electronic redemption codes. In one embodiment, the associating comprises at least naming the program (.exe file) with the one or more entities or the one or more entity transactions and the organization. The associating also comprises tagging in the database of the program with the one or more entities or the one or more entity transactions and the organization.

In the present implementation, the method further includes generating, by a code generator module, the one or more personalized set of electronic redemption codes for each of the entity based on execution of the program. In one embodiment, the program may be exported to a sperate computing system such as a desktop. In case of absence internet/network connectivity the program may be executed on the desktop for code generation, and the generated code may be update on the platform in case of internet connectivity.

In the present implementation, the method further includes creating equal number of electronic redemption codes for each of the selected entities. In another implementation, the method further includes creating unequal number of electronic redemption codes for each of the selected entities.

In one of the embodiments, a personalized electronic codes generation platform is disclosed. The platform comprises at least one processor, and at least one memory. The platform further comprises an input module, an entity definition module, a code definition module, and a code generator module coupled with the processor and the memory. In example, the platform is configured to register, by the input module, one or more organizations in a database based on verification using a unique identification process, wherein the one or more organizations are requesting personalized electronic redemption codes. Further to registering the platform is configured to create, by the entity definition module, one or more entities for each of the one or more organization and generate, by the code definition module, one or more entity transactions associated with the one or more entities. Subsequently the platform is configured to define, by the code definition module, a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets and generate, by the code definition module, at least one program to generate one or more set of personalized electronic redemption codes based on code sequence configuration and a set of processes, wherein the program is a software code. Finally, the platform is configured to associate, by the code definition module, at least one program with one of the one or more entities or the one or more entity transactions and generate, by a code generator module, the one or more personalized set of electronic redemption codes for each organization based on execution of the program.

In another embodiment, a non-transitory computer-readable medium storing processor-executable instructions that, when executed by one or more processors, are to cause the one or more processors to execute one or more instructions is disclosed. The non-transitory computer-readable medium comprise the instruction to register one or more organizations in a database based on verification using a unique identification process, wherein the one or more organizations are requesting personalized electronic redemption codes and create one or more entities for each of the one or more organization. Further the non-transitory computer-readable medium comprise the instruction to generate one or more entity transactions associated with the one or more entities and define a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets. Further the non-transitory computer-readable medium comprise the instruction to generate, at least one program to generate one or more set of personalized electronic redemption codes based on code sequence configuration and a set of processes, wherein the program is a software code and associate at least one program with one of the one or more entities or the one or more entity transactions. Finally, the non-transitory computer-readable medium comprise the instruction to generate the one or more personalized set of electronic redemption codes for each organization based on execution of the program.

It should be noted that the description merely illustrates the principles of the present subject matter. It will thus be appreciated that those skilled in the art will be able to devise various arrangements that, although not explicitly described herein, embody the principles of the present subject matter. Furthermore, all examples recited herein are principally intended expressly to be only for explanatory purposes to help the reader in understanding the principles of the subject matter and the concepts contributed by the inventor to furthering the art, and are to be construed as being without limitation to such specifically recited examples and conditions. Moreover, all statements herein reciting principles, aspects, and embodiments of the subject matter, as well as specific examples thereof, are intended to encompass equivalents thereof.

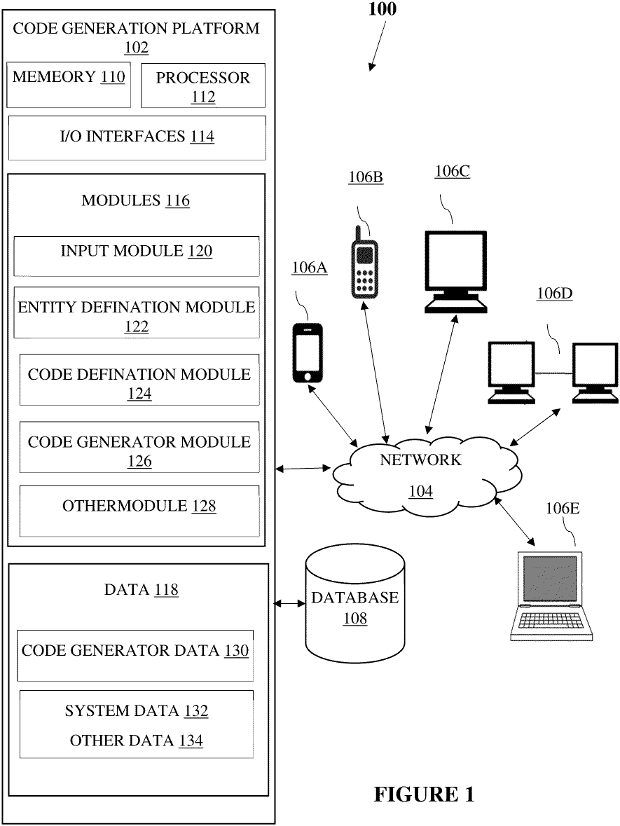

FIG. 1 illustrates a block diagram (100) depicting a personalized electronic codes generation platform (102), according to an exemplary implementation of the present subject matter. The personalized electronic codes generation platform (102) includes a network (104) a plurality of user devices 106 (106A, 106B, 106C, 106D, 106E), a database (108), a memory (110), a processor (112), I/O interfaces (114), a plurality of modules (116), and plurality of data (118).

The network (104) interconnects the user devices (106) and the database (108) with the personalized electronic codes generation platform (102). The network (104) includes wired and wireless networks. Examples of the wired networks include a Wide Area Network (WAN) or a Local Area Network (LAN), a client-server network, a peer-to-peer network, and so forth. Examples of the wireless networks include Wi-Fi, a Global System for Mobile communications (GSM) network, and a General Packet Radio Service (GPRS) network, an enhanced data GSM environment (EDGE) network, 802.5 communication networks, Code Division Multiple Access (CDMA) networks, or Bluetooth networks.

In the present implementation, the database (108) may be implemented as enterprise database, remote database, local database, and the like. The database (108) may be located within the vicinity of the personalized electronic codes generation platform (102) or may be located at different geographic locations as compared to that of the platform (102). Further, the database (108) may themselves be located either within the vicinity of each other or may be located at different geographic locations. Furthermore, the database (108) may be implemented inside the platform (102) and the database (108) may be implemented as a single database.

In the present implementation, the personalized electronic codes generation platform (102) includes one or more processors (112). The processor (112) may be implemented as one or more microprocessors, microcomputers, microcontrollers, digital signal processors, central processing units, state machines, logic circuitries, and/or any devices that manipulate signals based on operational instructions. Among other capabilities, the at least one processor (112) is configured to fetch and execute computer-readable instructions stored in the memory (110).

The I/O interface (114) may include a variety of software and hardware interfaces, for example, a web interface, a graphical user interface, and the like. The I/O interface (114) may allow the personalized electronic codes generation platform (102) to interact with a user directly or through the user devices (106). Further, the I/O interface (114) may enable the personalized electronic codes generation platform (102) to communicate with other user devices or computing devices, such as web servers and external data servers (not shown). The I/O interface (114) can facilitate multiple communications within a wide variety of networks and protocol types, including wired networks, for example, LAN, cable, etc., and wireless networks, such as WLAN, cellular, or satellite. The I/O interface (114) may include one or more ports for connecting several devices to one another or to another server.

The memory (110) may be coupled to the processor (112). The memory (110) can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory (110) also includes a cache memory to work with the personalized electronic codes generation platform (102) more effectively.

Further, the personalized electronic codes generation platform (102) includes modules (116). The modules (116) include routines, programs, objects, components, data structures, etc., which perform particular tasks or implement particular abstract data types. In one implementation, the module (116) includes an input module (120), an entity definition module (122), a code definition module (124), a code generator module (126) and other modules (128). The other modules (128) may include programs or coded instructions that supplement applications and functions of the personalized electronic codes generation platform (102).

Furthermore, in the present implementation, the personalized electronic codes generation platform (102) is configured to register, with the help of the input module (120), details of one or more organizations requesting a set of electronic redemption codes in the database (108).

The input module (120) further configured to verify the details of the one or more organizations requesting the set of electronic redemption codes in the database (108). Further, the input module (120) further configured to edit the details of the one or more organizations requesting the set of electronic redemption codes in the database (108) if the details of the one or more organizations is already available in the database (108). Here the one or more organizations refer to one or more business entity requesting the set of electronic redemption codes. For serving the purpose of the platform (102) to generate personalized electronic codes for multiple stakeholders/business entities, a master data is available, wherein a user can create the one or more organizations who has requested the personalized electronic codes.

In the present implementation, the personalized electronic codes generation platform (102) is further configured to create, with the help of the entity definition module (122), one or more entities having a list of parameters required for electronic redemption codes generation. Here the one or more entities refer to as a thing with distinct and independent existence used for the electronic redemption codes. The entity can also be referred as a set of distinct values, or a defined list required for the electronic redemption codes generation. For example, if a user wants to generate codes based on four regions (East, West, South, North), then user needs to define an entity named as “Region” on the code generation platform (102) (which is set of four (4) region values). Further, the entity definition module (122) configured to verify and edit the details of the one or more entities if the details of the one or more entities is already available in an entity master of the database (108). Furthermore, the entity definition module (122) configured to define entity transaction value length as well as change the status of the entity.

In the present implementation, the personalized electronic codes generation platform (102) is further configured to create, by a code definition module (124), one or more entity transactions. Here the one or more entity transactions refer to a list of value of an associated entity. Every entity with the entity types as “defined list” may have its own set of values. Here, for example, the entity transaction includes entity transaction name, associated entity and entity transaction code. In another example, if one can consider “state” as an entity, then the entity transaction values will be its associated list values, viz. Alabama, Alaska, Connecticut, California, and the like. Further, the code definition module (124) is further configured to verify and edit the existing entity transaction details as well as change the status of the entity transaction.

In the present implementation, the personalized electronic codes generation platform (102) is further configured to define, by the code definition module (124), a code sequence configuration. In one example the code sequence configuration comprises one or more of a maximum and a minimum number of characters, a list of inclusion and a list of exclusions. Further, the list of exclusion, and the list of inclusion comprises characters, words, and a sequence of characters and alphabets. In another example, the code sequence configuration includes random numbers or characters, separator, text, entity code, code end date, status and the like. Furthermore, the code definition module (124) is configured to define number of characters in the code and provide a list of exclusions of certain characters which does not become a part of the final generated set of electronic redemption codes. For example, the code sequence configuration may include a nine (9) characters code where the character “o”, “1”, “!”, “#” should be excluded while generating the electronic codes. The electronic codes must have an end date which state that the electronic codes must expire within 90 days from the date these are generated. In the present implementation, the code definition module (124) is further configured to include one or more specific characters at specific code sequences as per organizational requirement. For example, the organization wants to generate a 6 characters long code in which character number 4 from the right must be an entity and character number 5 from the right must be a city. Furthermore, the personalized electronic codes generation platform (102) is further configured to allow a user to define the one or more entity as a part of the final generated set of electronic redemption codes by including it in the code sequence configuration, and wherein the final generated set of electronic redemption codes validity based on type of the code end date selected at the time of generating codes. For example, a user can define that his nine (9) character long codes must start with the entity code having “DL” and followed by five (5) characters randomly generated followed by two (2) characters city code “NY” with a validity of 31 days from the date of generation of such codes. In another example, the code sequence can be defined as “random numbers″- “city code” - “random numbers” with a validity of 37 days from the date of generation of such codes.

In the present implementation, the personalized electronic codes generation platform (102) is further configured to generate, by the code definition module (124), at least one program to generate one or more set of electronic redemption codes. Here the program refers a software code such as .exe comprising a set of processes and the code generation sequence for generating electronic redemption codes. In one example the set of process may be understood as a line of codes defining the code generation process and embedding the data in the code and creating a local output. The set of processes may also include prompts to a user of the organization, while execution of the program, the prompts may be for alerts or data. It is important that a particular program always has validity period (based on user’s input). In the course, the program includes selecting entities for electronic redemption codes generation. Further, the program includes preview and generate a test electronic redemption code. The program also has the provision to include the option of editing the existing program.

In the present implementation, the personalized electronic codes generation platform (102) is further configured to associate, with the help of the code definition module (124), the at least one program with one or more entities or entities transactions.

In the present implementation, the personalized electronic codes generation platform (102) is further configured to generate, with the help of the code generator module (126), the one or more personalized set of electronic redemption codes for each organization based on execution of the program. In the present implementation, the program is further configured to create equal number of electronic redemption codes for each of the selected entities. In another implementation, the program is further configured to create unequal number of electronic redemption codes for each of the selected entities.

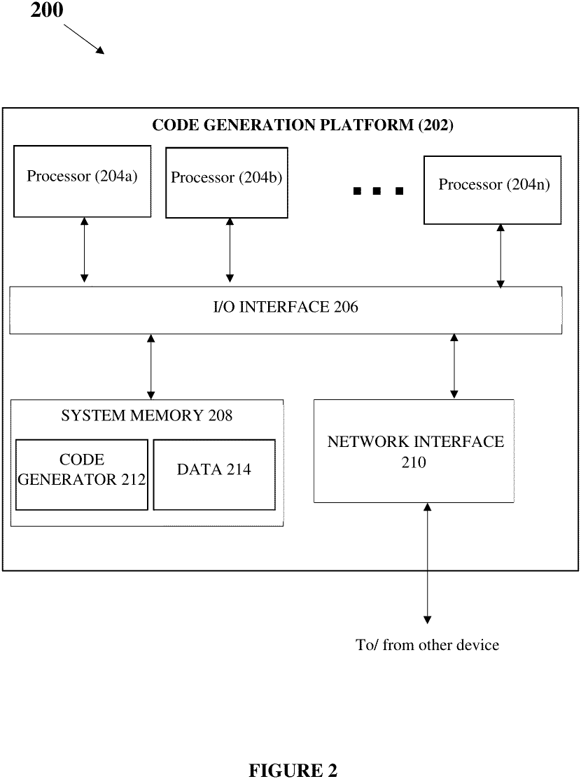

FIG. 2 illustrates a block diagram (200) depicting a code generation platform (202), according to an exemplary implementation of the present subject matter. The code generation platform (202) includes processors (204a, 204b... 204n), an I/O interface (206), system memory (208) and a network interface (210). The system memory (208) includes code generator data (212) and other data (data) (214).

In this present implementation, the system memory (208) or a non-transitory computer-readable medium (208) storing processor-executable instructions (212) that, when executed by one or more processors (204a ... 204n), are to cause the one or more processors (204) to register details of one or more organizations requesting a set of electronic redemption codes in a database; create one or more entities having a list of parameters required for electronic redemption codes generation; create one or more entity transactions; define a code sequence configuration to generate the one or more personalized set of electronic redemption codes, generate at least one program to generate one or more set of electronic redemption codes; associate the at least one program with one or more entities or one or more entity transactions; and generate the one or more personalized set of electronic redemption codes based on execution of the program.

Now construe an example of an implementation of the present subjective. It should be understood that the example described with reference to FIG. 1 and FIG. 2 should not be considered as a limitation to the scope of the claim. In the example, construe multiple organization for example PEPSI® and GILLETTE® having stores across country such as India are intending to run a promotion program on the same day for a festival. In a diverse country such as India, the same festival, called by different name, or different festivals occurs on the same day in the different region/states, for example Thai Pongal (Tamil Nādu), Uttarayan (Gujarat), Lohri (Punjab), Poush sôngkrānti (Bengal) Suggi Habba (Karnataka), Makara Chaula (Odisha), Sankranti (Maharashtra and Haryana), Magh/Bhogali Bihu (Assam) all occur on the same day. Conventional technologies fail to address the problem of providing customization in such granularity. This problem multiplies when the multiple organizational like PEPSI® and GILLETTE® with multiple brand under their company and multiple stores/ platforms selling their product intend to run a customized and personalized promotion campaign through code redemption. Further in countries like INDIA where internet connectivity is a challenge a platform that enables customization and personalization of redemption that can enable the promotion/ code generation both in absence and presence of internet is described in the example. Further the organization want to control the parameters of the redemption centrally , where’s the generation and execution of the promotion can be done in their local shops , in distributed manner.

The following table illustrates one other example of the complexity of the generation of personalized code generation.

| | | | | |
|---|---|---|---|---|
| Organization | Festival | Store/seller | Entity 1 | Entity Transaction 1 |
| Pepsi® | Father Day | A | States | GOA, Maharashtra, Karnataka, assam |
| | | B | | Andhra Pradesh |
| | Mother Day | A | | Arunachal Pradesh., Bihar |
| | | B | | Andhra Pradesh |
| LAPINE™ | Father Day | A | | GOA, Maharashtra, Karnataka, assam |
| | | B | | Andhra Pradesh |
| | | C | | Arunachal Pradesh., Bihar |
| | Mother Day | A | | Andhra Pradesh |
| | | B | | GOA, Maharashtra, Karnataka, assam |
| | | C | | Andhra Pradesh |

Referencing back to the example the organization Pepsi®, LAPINE™, GILLETTE® may utilized the personalized electronic codes generation platform (102) for generation of personalized redemption code.

In the example, the input module (120) further configured to verify the details of the one or more organizations requesting the set of electronic redemption codes in the database (108), such as Pepsi®, LAPINE™,GILLETTE®. The verification may be based on a unique identification process such as using OTP verification or id verification. Further, the input module (120) further configured check and to edit the details of the organizations requesting the set of electronic redemption codes in the database (108) if the details of the organizations is already available in the database (108).

In the present implementation, the personalized electronic codes generation platform (102) is further configured to create, with the help of the entity definition module (122), one or more entities having a list of parameters required for electronic redemption codes generation. For example, all organization Pepsi®, LAPINE™,GILLETTE® want to generate codes based on “states. Further, the entity definition module (122) configured to verify and edit the details of the one or more entities if the details of the one or more entities is already available in an entity master of the database (108).

In the present implementation, the personalized electronic codes generation platform (102) is further configured to create, by a code definition module (124), one or more entity transactions. Here the one or more entity transactions refer to a list of value of an associated entity. In the example, if one can consider “state” as an entity, then the entity transaction values will be its states as illustrated in table above. Further, the code definition module (124) is further configured to verify and edit the existing entity transaction details as well as change the status of the entity transaction.

In the present example, the personalized electronic codes generation platform (102) is further configured to define, by the code definition module (124), a code sequence configuration. In one example the code sequence configuration comprises one or more of a maximum and a minimum number of characters like 15- 20, a list of inclusion and a list of exclusions. Further, the list of exclusion, and the list of inclusion comprises characters , words, and a sequence of characters and alphabets. In another example, the code sequence configuration includes random numbers or characters, separator, text, entity code, code end date, status and the like. Furthermore, the code definition module (124) is configured to define number of characters in the code and provide a list of exclusions of certain characters which does not become a part of the final generated set of electronic redemption codes. For example, the code sequence configuration may include a nine (9) characters code where the character “o”, “1”, “!”, “#” should be excluded while generating the electronic codes or any derogatory words. In one example, Pepsi® may want to exclude name of any competitor brand i.e. alphabet c, o, a, 1, and the sequence to read “Coca-Cola®”. The electronic codes must have an end date which state that the electronic codes must expire within 2 days from the date these are generated. In the present implementation, the code definition module (124) is further configured to include one or more specific characters at specific code sequences as per organizational requirement. For example, the organization wants to generate a 6 characters long code in which character number 4 from the right must be an entity and character number 5 from the right must be a city. Furthermore, the personalized electronic codes generation platform (102) is further configured to allow a user to define the one or more entity as a part of the final generated set of electronic redemption codes by including it in the code sequence configuration, and wherein the final generated set of electronic redemption codes validity based on type of the code end date selected at the time of generating codes. For example, a user can define that his nine (9) character long codes must start with the entity code having “IN” and followed by five (5) characters randomly generated followed by two (2) characters State code “MH” .

In the present implementation, the personalized electronic codes generation platform (102) is further configured to generate, by the code definition module (124), at least one program to generate one or more set of electronic redemption codes. Here the program refers a software code such as .exe comprising a set of processes and the code generation sequence for generating electronic redemption codes. In one example the set of process may be understood as a line of codes defining the code generation process and embedding the data in the code and creating a local output. The set of processes may also include prompts to a user of the organization, while execution of the program, the prompts may be for alerts or data. It is important that a particular program always has validity period (based on user’s input). In the course, the program includes selecting entities for electronic redemption codes generation. Further, the program includes preview and generate a test electronic redemption code. The program also has the provision to include the option of editing the existing program.

In the present implementation, the personalized electronic codes generation platform (102) is further configured to associate, with the help of the code definition module (124), the at least one program with one or more entities or entities transactions.

In the present implementation, the programs for generation is provided to the each of the organization Pepsi®, LAPINE™,GILLETTE®, where the customization of the program is done as per the requirement of the organization. The organization can now share the program instead of the code to all the outlet online distributors for generation of the personalized unique redemption code. The individual shop owners online aggregators and the like may executed the program such as .exe to generate the personalized redemption code as per the organization requirements. The .exe can perform with or without internet, enabling MNC such as Pepsi®, LAPINE™,GILLETTE® to enable promotion locally where regular and strong internet connectivity is an issue.

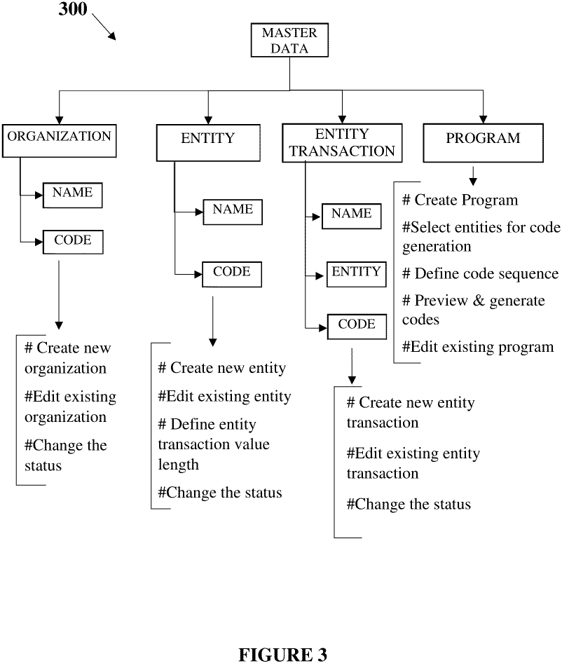

FIG. 3 illustrates a block diagram (300) depicting a master data for each of the modules (parameters) for generating electronic redemption codes, according to an exemplary implementation of the present subject matter. The present subject matter provides a centralized platform for generating the electronic redemption codes based on the request raised by the business entities, using which end user can log in to the respective redemption systems/applications/platforms and redeem the product using valid electronic redemption codes. The present subject matter provides extensive code generation based on completely customized entity selection. The present code generation platform (102, 202) provides organization module, entity master module, entity transaction module and program module for customized electronic redemption codes generation experience to the user.

In the present implementation, the master data/ master entity of the code generation platform (102, 202) includes the organization module, the entity master module, the entity transaction module and the program module. The organization module provides an option to add new organization/client information on the code generation platform (102, 202). It also provides an option to edit the existing organization/client information on the code generation platform (102, 202). Also, it provides an option to change the status of the organization/client.

In the present implementation, the entity master module provides an option to add/create new entity on the code generation platform (102, 202). It also provides an option to edit the existing entity information on the code generation platform (102, 202). Also, it provides an option to change the status of the entity. Further, it also provides an option to define entity transaction value length.

In the present implementation, the entity transaction module provides an option to add/create new entity transaction on the code generation platform (102, 202). It also provides an option to edit the existing entity transaction information on the code generation platform (102, 202). Also, it provides an option to change the status of the entity transaction.

In the present implementation, the program module provides an option to add/create program for generating electronic redemption codes on the code generation platform (102, 202). It provides an option to select entities for electronic redemption code generation. It also provides an option to define the code sequence for the final electronic redemption code so that the user can completely customize the final codes as per the requirements. The program module also provides an option to preview the electronic redemption code prior to generating it. And, finally, the program module provides the option to generate the electronic redemption code.

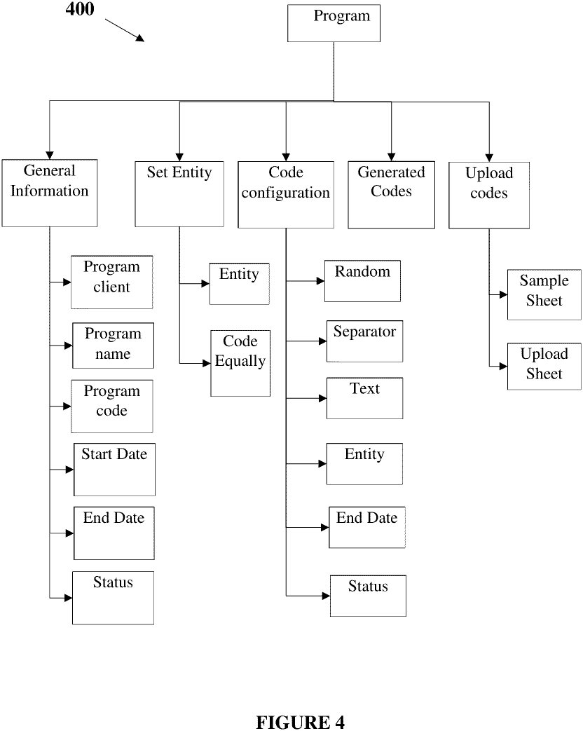

FIG. 4 illustrates a block diagram (400) depicting a configuration of program to generate set of electronic redemption codes, according to an exemplary implementation of the present subject matter. The program may be understood as a software such as a .exe. The .exe would comprise various meta data regarding the execution of the code and the expected output. The .exe may comprise a user interface for obtaining user input such as number of code to be generated while execution of .exe. The program module includes software block such as a general information block, set entity block, code configuration block, generated codes block and upload codes block. The general information block includes the information pertaining to program client (organization), program name, program code, start date, end date and status. The set entity block includes the entity information as well as equal code for the specific entity. The code configuration includes settings for includes the options of random numbers/characters, separator, text, entity name/code, end date and status. These information acts as a plurality of attributes for the generated codes and giving an option to the end user to completely customize the code generation process, thereby, receiving a completely customized set of electronic redemption codes. Further, the generated codes block includes the details and actual electronic redemption codes. The upload codes block includes a sample sheet and upload sheet option to export the final electronic redemption codes.

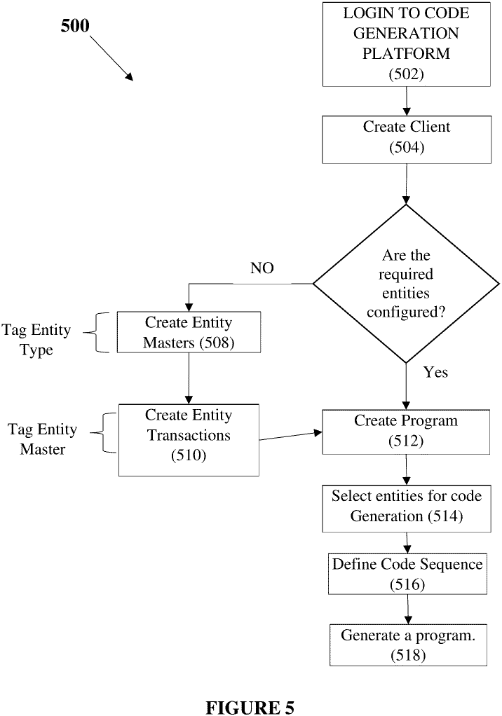

FIG. 5 illustrate a flowchart (500) depicting a complete process for generating personalized electronic codes, according to an exemplary implementation of the present subject matter.

At step 502, a user login to a code generation platform (102, 202). The platform is not depicted in the flowchart. At step 504, the user creates client/organization. Once the entity is created at step 504, the verification of one or more entities initiated. At step 506, the platform enquires whether the required entities are configured as per the requirements or not. If no, go to step 508 otherwise go to step 512. At step 508, entity master(s) is created and tagged with the appropriate entity type. At step 510, an entity transaction is created, and appropriate values are assigned which are further tagged with the entity master. At step 512, a program is created to generate personalized electronic codes. At step 514, appropriate entities are mapped with the program for personalized electronic codes generation. At step 516, the platform provides an option to define the code sequence by which the personalized electronic codes are completely customized by the end user. At step 518, the platform generates a program, wherein the program is a portable software code packaged as an .exe (executable file). Upon execution of the .exe the personalized code generation is done. The .exe is stored in the database for further use.

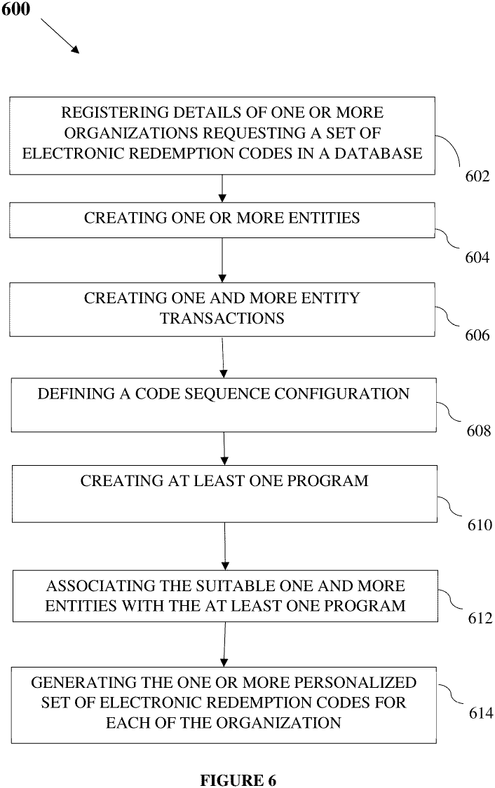

FIG. 6 illustrate a flowchart depicting a computer implemented method for generating personalized electronic codes, according to an exemplary implementation of the present subject matter.

At step 602, registering, by an input module, details of one or more organizations requesting a set of electronic redemption codes in a database.

At step 604, creating, by an entity definition module, one or more entities having a list of parameters required for electronic redemption codes generation.

At step 606, creating, by a code definition module, one or more entity transactions.

At step 608, defining, by the code definition module, a code sequence configuration.

At step 610, creating, by the code definition module, at least one program to generate one or more set of electronic redemption codes, wherein the program is a software code such as a .exe.

At step 612, associating, by the code definition module, the suitable one or more entities with the at least one program to generate the one or more set of electronic redemption codes.

And, at step 614, generating, by a code generator module, the one or more personalized set of electronic redemption codes for each of the entity.

It should be noted that the description merely illustrates the principles of the present subject matter. It will thus be appreciated that those skilled in the art will be able to devise various arrangements that, although not explicitly described herein, embody the principles of the present subject matter. Furthermore, all examples recited herein are principally intended expressly to be only for explanatory purposes to help the reader in understanding the principles of the subject matter and the concepts contributed by the inventor to furthering the art and are to be construed as being without limitation to such specifically recited examples and conditions. Moreover, all statements herein reciting principles, aspects, and embodiments of the subject matter, as well as specific examples thereof, are intended to encompass equivalents thereof.

We claim:

1. A computer implemented method for generating personalized electronic redemption codes, the method comprising:
registering, by an input module, one or more organizations in a database based on verification using a unique identification process, wherein the one or more organizations are requesting personalized electronic redemption codes;
creating, by an entity definition module, one or more entities for each of the one or more organization;
generating, by a code definition module, one or more entity transactions associated with the one or more entities;
defining, by the code definition module, a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets;
generating, by the code definition module, at least one program to generate one or more set of personalized electronic redemption codes based on code sequence configuration and a set of processes, wherein the program is a software code;
associating, by the code definition module, at least one program with one of the one or more entities or the one or more entity transactions;
generating, by a code generator module, the one or more personalized set of electronic redemption codes for each organization based on execution of the program.

2. The method of claim 1, wherein the step of verifying further includes editing the details of the one or more organizations requesting the set of electronic redemption codes in the database if the details of the one or more organizations is already available in the database.

3. The method of claim 1, wherein the step of creating one or more entity transactions further includes verifying and editing the existing entity transaction.

4. The method of claim 1, wherein the code sequence configuration includes random numbers or characters, separator, text, entity code, code end date, and status.

5. The method of claim 1, wherein the program is stored in in a software code database for reuse.

6. The method of claim 1, wherein the method further comprising allowing a user to define the one or more entity as a part of the generated set of personalized electronic redemption codes, and wherein the generated set of personalized electronic redemption codes validity based on type of the code end date selected at the time of generating codes.

7. A personalized electronic codes generation platform comprising:
at least one processor, and at least one memory;
an input module, an entity definition module, a code definition module, and a code generator module coupled with the processor and the memory,
wherein the platform configured to:
register, by the input module, one or more organizations in a database based on verification using a unique identification process, wherein the one or more organizations are requesting personalized electronic redemption codes;
create, by the entity definition module, one or more entities for each of the one or more organization;
generate, by the code definition module, one or more entity transactions associated with the one or more entities;
define, by the code definition module, a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets.
generate, by the code definition module, at least one program to generate one or more set of personalized electronic redemption codes based on code sequence configuration and a set of processes, wherein the program is a software code;
associate, by the code definition module, at least one program with one of the one or more entities or the one or more entity transactions; and
generate, by a code generator module, the one or more personalized set of electronic redemption codes for each organization based on execution of the program.

8. The platform of claim 7, wherein the step of verifying further includes editing the details of the one or more organizations requesting the set of electronic redemption codes in the database if the details of the one or more organizations is already available in the database.

9. The platform of claim 7, wherein the step of creating one or more entity transactions further includes verifying and editing the existing entity transaction.

10. The platform of claim 7, wherein the code sequence configuration includes random numbers or characters, separator, text, entity code, code end date, and status.

11. The platform of claim 7, wherein the method further comprising allowing a user to define the one or more entity as a part of the generated set of personalized electronic redemption codes, and wherein the generated set of personalized electronic redemption codes validity based on type of the code end date selected at the time of generating codes.

12. The platform of claim 7, wherein the program is stored in in an software code database for reuse.

13. A non-transitory computer-readable medium storing processor-executable instructions that, when executed by one or more processors, are to cause the one or more processors to:
register one or more organizations in a database based on verification using a unique identification process, wherein the one or more organizations are requesting personalized electronic redemption codes;
create one or more entities for each of the one or more organization;
generate one or more entity transactions associated with the one or more entities;
define a code sequence configuration, wherein the code sequence configuration comprises one or more of a maximum and a minimum number of characters, a list of inclusion and a list of exclusions, wherein the list of exclusion, and the list of inclusion comprises characters, words, and a sequence of characters and alphabets.
generate, at least one program to generate one or more set of personalized electronic redemption codes based on code sequence configuration and a set of processes, wherein the program is a software code;
associate at least one program with one of the one or more entities or the one or more entity transactions; and
generate the one or more personalized set of electronic redemption codes for each organization based on execution of the program.
